(19) United States
(12) Patent Application Publication
(10) Pub. No.: US 2013/0195303 A1
(43) Pub. Date: Aug. 1, 2013

(54) HEARING AID

(71) Applicant: PANASONIC CORPORATION, Osaka (JP)

(72) Inventor: Minoru TADA, Ehime (JP)

(73) Assignee: PANASONIC CORPORATION, Osaka (JP)

(21) Appl. No.: 13/741,646

(22) Filed: Jan. 15, 2013

(30) Foreign Application Priority Data
Jan. 30, 2012 (JP) 2012-016649

(51) Int. Cl. H04R 25/00

(52) U.S. Cl. CPC H04R 25/602
USPC 381/323

(57) ABSTRACT

With this hearing aid, when a battery case (2) is pulled out from a main body case (1), a battery (3) is held in place by a magnet (9) provided to the bottom portion (8) of the battery case (2). When the battery (3) is taken out, a finger (10) is inserted into a battery case compartment (4) of the main body case (1). At this point the finger (10) goes into a cut-out portion (7) provided to the battery case (2) and touches the battery (3), so the battery (3) is taken out by moving the finger (10) downward.

### CROSS-REFERENCE TO RELATED APPLICATIONS

This application claims priority to Japanese Patent Application No. 2012-016649 filed on Jan.30, 2012. The entire disclosure of Japanese Patent Application No. 2012-016649 is hereby incorporated herein by reference.

### BACKGROUND OF THE INVENTION

1. Field of the Invention

The present invention relates to a hearing aid with which battery holding and battery replacement are easy.

2. Description of the Related Art

A conventional hearing aid comprises a main body case, a battery case retractably provided to the main body case, a hearing aid processor provided inside the main body case, and a microphone and receiver connected to the hearing aid processor. The main body case has a holding space for holding the battery case, and an opening for deploying the battery case from the holding space.

Also, this battery case has a substantially C-shaped battery holder that covers the sides of the battery, and is configured so that the battery is held by press-fitting the battery into the battery holder (see Patent Literature 1, for example).

### CITATION LIST

### Patent Literature

Patent Literature 1: Japanese Laid-Open Patent Application 2007-172839

### SUMMARY

With the shape of the battery case disclosed in the above-mentioned Patent Literature 1, the sides of the battery are held by at least two support points (support portions) in the C-shaped battery holder. Therefore, the battery can be held at these two support points.

However, with a configuration in which the sides of the battery are held by two support points (support portions), there is the risk that the battery will fall out if the holding force is not strong enough at these support points.

In view of this, when the sides of the battery are held securely by the two support points (support portions), these two support points (support portions) have to be spread apart with a powerful force when the battery is being installed or when it is being replaced, for example. This makes it less convenient for the user during battery replacement, etc.

This work can be particularly difficult for elderly users of a hearing aid.

### PROBLEM TO BE SOLVED BY THE INVENTION

In view of this, it is an object of the present invention to make battery replacement more convenient while still holding the battery in place with sufficient force.

### MEANS FOR SOLVING PROBLEM

To achieve the stated object, the present invention comprises a main body case, a battery case, a bottomed, cylindrical battery compartment, a retainer, a battery case compartment, and a cut-out portion. The battery case is retractably provided to the main body case. The bottomed, cylindrical battery compartment is provided to the battery case, and a battery can be inserted and removed from an open first end side. The retainer is provided to the bottom portion of the battery compartment and holds the battery toward the bottom portion. The battery case compartment is provided to the main body case, and holds the battery case. The cut-out portion is provided at a location on the battery case that is adjacent to the battery case compartment and into which part of a finger is inserted in a state in which the battery case has been pulled out of the main body case.

### EFFECTS OF THE INVENTION

With the present invention, since the battery can be put into the battery compartment from the open end side, battery is easier than in the past, while the battery can be held in place by the retainer.

### BRIEF DESCRIPTION OF DRAWINGS

FIG. 1 is a top oblique view of the state when the battery case has been pulled out of the hearing aid pertaining to an embodiment of the present invention;

FIG. 2 is an oblique view of the hearing aid in FIG. 1 as seen from the battery case compartment side;

FIG. 3 is a view of the battery case when the battery has been installed, in the hearing aid in FIG. 1;

FIG. 4 is an oblique view illustrating the state of first and second electrodes that are connected to the battery in the hearing aid in FIG. 1; and

FIG. 5 is an oblique view illustrating the state when the battery is pulled out from the battery case in the hearing aid in FIG. 1.

### DETAILED DESCRIPTION OF THE INVENTION

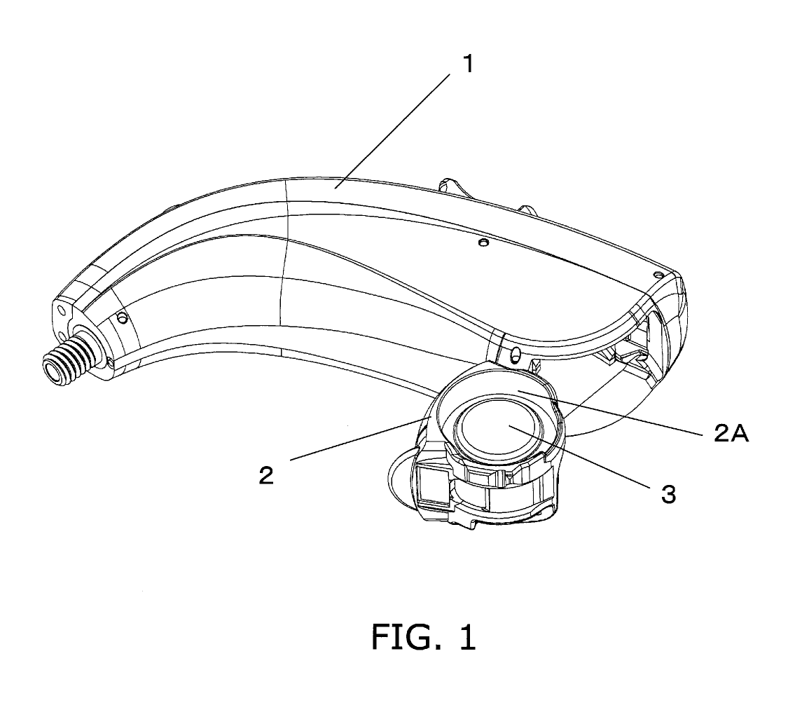

The hearing aid pertaining to an embodiment of the present invention will now be described through reference to FIGS. 1 to 5.

### Embodiment 1

FIG. 1 shows a behind-the-ear (BTE) type of hearing aid.

The hearing aid in this embodiment comprises a main body case 1 that is mounted behind the hear, and a battery case 2 that is attached to one end of the main body case 1 so as to be retractable into the main body case 1.

The battery case 2 is open on a first end side (the top face in FIG. 1), and has a bottomed, cylindrical battery compartment 2A into which a battery 3 (air battery) is installed and from which it is removed from the open first end side. The battery 3 is inserted into the battery compartment 2A from the open end side.

FIG. 1 shows the state of the hearing aid when the battery 3, which supplies power for driving the hearing aid, has been put into the battery compartment 2A of the battery case 2, which has been pulled out of the main body case 1.

Also, while not depicted in the drawings, as is commonly known, the hearing aid in this embodiment comprises inside the main body case 1 a microphone for collecting ambient sounds, and a receiver for outputting sounds that have undergone hearing aid processing as air vibrations. Consequently, this hearing aid can operate as an ordinary hearing aid.

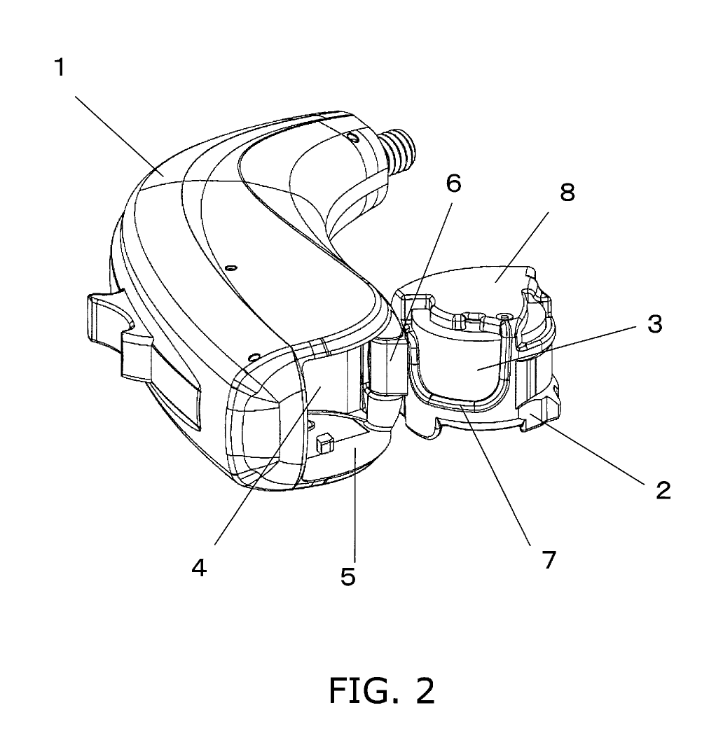

FIG. 2 is an oblique view of the hearing aid in FIG. 1 as seen from the lower side of the main body case 1 (the side on which a battery case compartment 4 is provided).

The main body case 1 has the battery case compartment 4 for holding the battery case 2 in the interior of the main body case 1. The battery case compartment 4 has an opening 5 through which the battery case 2 moves in and out of the battery case compartment 4.

The battery case compartment 4 is provided so as to form a substantially U-shaped inner wall in cross section view as seen from above in FIG. 2. The open side of the substantially U-shaped inner wall coincides with the direction in which a cut-out portion 7 is provided to the battery case 2, and is large enough for at least part of a person's fingertip to fit inside.

A shaft portion 6 for rotatably attaching the battery case 2 and the battery case compartment 4 is provided to the end of the main body case 1. In a state in which the battery case 2 has been rotated around the shaft portion 6 and pulled out from the main body case 1, the cut-out portion 7 (the right side of the shaft portion 6 in FIG. 2) that passes through the battery compartment 2A and the outside is provided at a location that is opposite the battery case compartment 4, with the shaft portion 6 in between.

Specifically, the cut-out portion 7 is provided at a location that 9s adjacent to the battery case compartment 4 in the battery case 2 in a state in which the battery case 2 has been pulled out from the main body case 1. The cut-out portion 7 is provided to the side face of the battery case 2. As shown in FIG. 2, the end face of the cut-out portion 7 is substantially U-shaped. The substantially U-shaped open side coincides with the side where the bottomed, cylindrical bottom portion of the battery case 2 (the top face of the battery case 2 in FIG. 2) is provided. This forms a support portion 11 on the side face of the battery case 2.

The support portion 11 supports the battery 3 held in the battery compartment 2A so that there is no tilt.

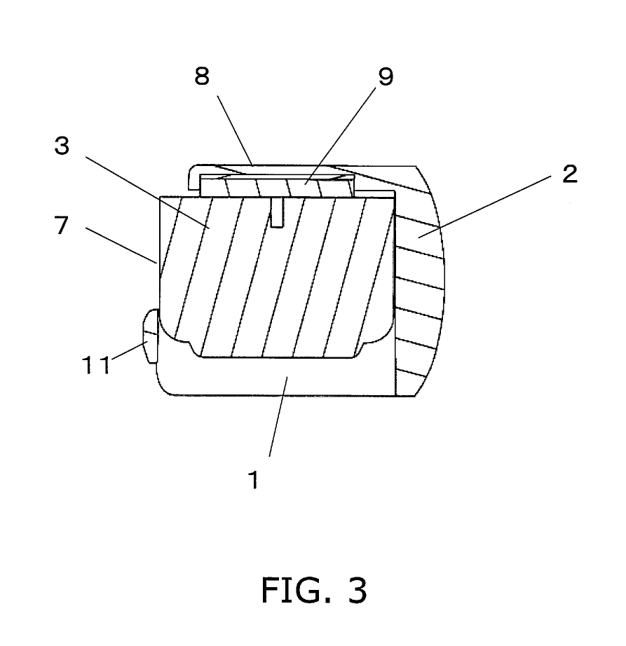

A magnet 9 (see FIG. 3) (given as an example of a retainer) is provided at the bottom portion 8 of the battery case 2.

In this embodiment, because the magnet 9 is provided at the bottom portion 8 of the battery case 2, when the battery 3 is inserted into the battery compartment 2A, the battery 3 is held on the bottom portion 8 by magnetic force, so the battery 3 can be stably retained inside the battery compartment 2A. Thus, even if the two support points are not forcefully pressed in as in the past, the battery 3 can be easily held in place merely by lightly placing it in the battery compartment 2A. This makes battery replacement easier than in the past.

Air batteries are generally used in hearing aids, and generate electricity when an air hole on the battery surface is opened.

In this embodiment, in a state in which the battery case 2 has been pulled out from the main body case 1, the battery 3 is retained by the magnet 9 provided at the bottom portion 8 of the battery compartment 2A, and the air hole (not shown) of the battery 3 is touching and blocked off by the bottom portion 8.

On the other hand, in a state in which the battery case 2 is housed in the main body case 1, the battery 3 is moved by a specific distance (preferably, 0.2 to 0.4 mm, for example) from the magnet 9 to the open end side of the battery compartment 2A (downward in FIG. 1) in order to open up the air hole of the battery 3.

A convex component (not shown) provided to a face opposite the bottom portion 8 of the battery case 2 in the battery case compartment 4 of the main body case 1, for example, can be used as the means for moving the battery 3 in this way. The configuration may be such that a cut-out portion that goes through the space on the battery compartment side is provided to the bottom portion 8 of the battery case 2 so as not to interfere with the convex component when the battery case 2 is housed in the battery case compartment 4, and the battery 3 is pushed up by the convex component through this cut-out portion. This allows the battery 3 to be moved by the specified distance to the open end side of the battery compartment 2A.

Because the battery 3 housed in the battery compartment 2A is supported without tilt by the support portion 11 formed on the side face of the battery case 2, the battery 3 can move more smoothly.

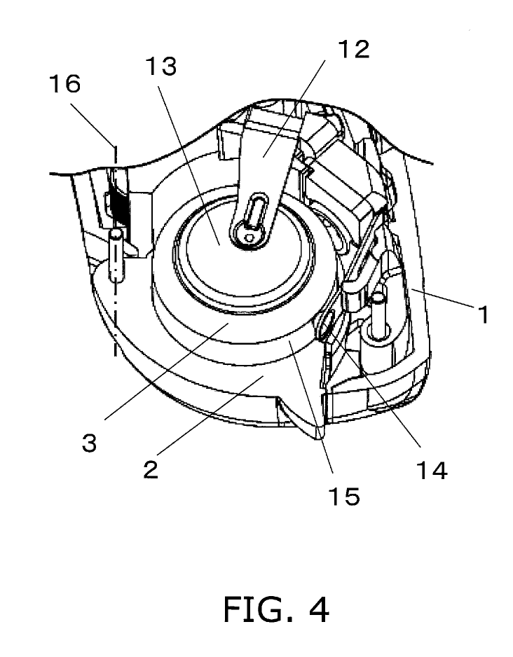

As shown in FIG. 4, a pair of electrodes first and second electrodes 12 and 14 for taking off power from the battery 3 comes into contact with the battery 3.

As shown in FIG. 4, in a state in which the battery case 2 is housed in the main body case 1, the first electrode 12 is disposed so as to touch the top face 13 of the battery 3 exposed from the open end of the battery compartment 2A. The second electrode 14, meanwhile, is disposed so as to touch the side face 15 of the battery 3.

The location where the second electrode 14 in contact with the side face 15 of the battery 3 comes into contact with the battery 3 is preferably to the outside (the opening 5 (see FIG. 2) side of the battery case compartment 4) of a line that connects the center of the battery 3 with the rotational center of the battery case 2 when viewed in the direction of the rotational axis 16 of the battery case 2 shown in FIG. 4.

Consequently, the electrode 14 exerts a force that pushes the battery 3 toward the inside of the battery case compartment 4. Therefore, since the direction in which the electrode 14 pushes the battery 3 is the opposite of the direction in which the battery case 2 is pulled out, the battery case 2 can be securely housed inside the main body case 1.

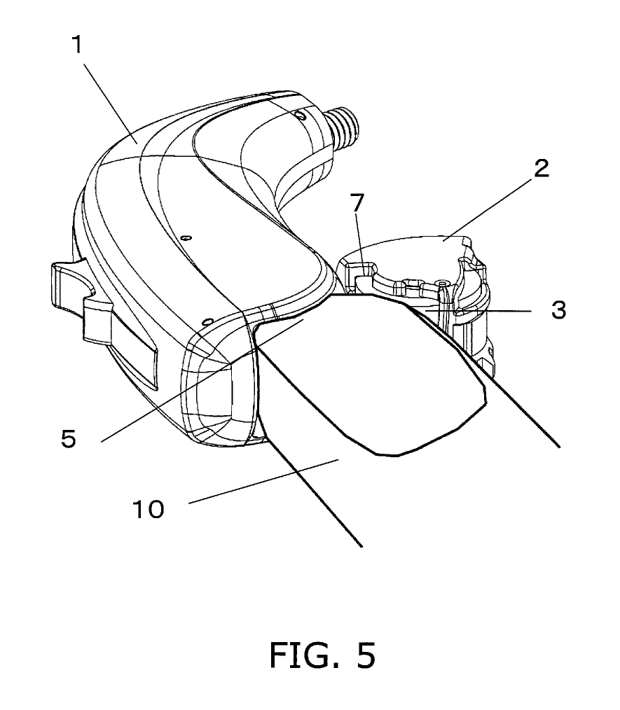

Next, the procedure entailed in removing the battery 3 from the battery compartment 2A will be described through reference to FIG. 5.

When the battery 3 is removed from the battery compartment 2A, first the battery case 2 is pulled out from the main body case 1, and the main body case 1 is upside-down (a state in which the open end side of the battery compartment 2A faces the direction in which gravity acts). This results in a state in which the battery 3 can fall out under its own weight.

At this point, however, since the battery 3 is retained by the magnet 9, the battery 3 is still held inside the battery compartment 2A.

Then, as shown in FIG. 5, a finger 10 is inserted into the battery case compartment 4 through the opening 5 in the battery case compartment 4.

Here, the side face of the finger 10 on the opposite side from the side facing the battery case compartment 4 is directly touching the battery 3 through the cut-out portion 7. In this state, if the finger 10 is lightly moved downward (from the bottomed, cylindrical bottom portion 8 of the battery compartment 2A toward the open end), the battery 3 can be extricated from the attractive force of the magnet 9 provided to the bottom portion 8 of the battery case 2. This allows the battery 3 to fall out under its own weight, and allows the battery 3 to be easily removed from the battery case compartment 4.

The battery 3 can also be removed by inserting the finger 10 directly into the cut-out portion 7. However, hearing aid users are typically elderly, and these elderly users may have diminished eyesight. Therefore, performing fine tasks with the fingertips may be extremely difficult for an elderly user, so a problem is that directly inserting the finger 10 into the cut-out portion 7, which is a small hole, can be difficult and frustrating.

With the hearing aid in this embodiment, the battery case compartment 4 functions as a guide when the finger 10 is inserted into the battery case compartment 4 in which the battery case compartment 4 is formed as an opening that is larger than the cut-out portion 7 on the battery case 2 side. Thus, even an elderly user can easily hold the finger 10 at the specific location for removing the battery 3.

Therefore, in a state in which the finger 10 has been inserted into the space of the battery case compartment 4, one of the surfaces of the finger 10 will always come into contact with the battery 3. Thus, removal of the battery 3 is a simple matter of moving the finger 10 downward. As a result, even an elderly user can be easily remove the battery 3, and this makes battery replacement easier than in the past.

In this embodiment, a behind-the-ear type of hearing aid was given as an example, but the present invention is not limited to this. For example, the present invention can also be applied to an in-the-ear type of hearing aid.

Also, the magnet 9 is more preferably one that is elastic, such as a plastic magnet. If it is elastic, it will bend and conform to the surface shape of the battery 3, allowing the air hole of the battery 3 to be blocked off more reliably.

### (Effect)

With this hearing aid, in a state in which the battery case has been pulled out from the battery case compartment during replacement of the battery, there is a cut-out portion at a location of the battery case that is adjacent to the battery case compartment. Therefore, the battery can simply be separated from the battery compartment and the battery replaced, merely by pushing the battery downward from the cut-out portion (from the bottomed, cylindrical bottom portion of the battery compartment toward the open end). As a result, the product is easier to use than in the past.

Specifically, with this hearing aid, during the above-mentioned battery replacement, in a state in which the battery case has been pulled out of the main body case, for example, the index finger is just inserted into the empty battery case compartment, and this space serves as a guide so that part of the index finger can be brought into contact with the battery through the cut-out portion.

In this state, the battery can be moved to the open end side merely by moving the fingertip a little toward the open end of the battery compartment, so the battery can be easily taken out of the battery compartment. As a result, battery replacement is easier than in the past.

### INDUSTRIAL APPLICABILITY

With the hearing aid of the present invention, when the battery case is pulled out of the main body case, the battery is held in place by a magnet provided to the bottom portion of the battery case, and when the battery is taken out, a finger inserted into the battery case compartment of the main body case is put into a cut-out portion provided to the battery case, allowing the battery to be removed, so the effect is that battery replacement can be carried out more easily than in the past, and therefore the present invention is expected to find wide application to various kinds of hearing aid.

### REFERENCE SIGNS LIST

1 main body case

2 battery case

2A battery compartment

3 battery

4 battery case compartment

5 opening

6 shaft portion

7 cut-out portion

8 bottom portion

9 magnet (retainer)

10 finger

11 support portion

12 first electrode

13 top face

14 second electrode

15 side face

16 rotational axis

1. A hearing aid, comprising:
a main body case;
a battery case retractably provided to the main body case;
a bottomed, cylindrical battery compartment that is provided to the battery case and into and from which a battery can be inserted and removed from an open first end side;
a retainer that is provided to the bottom portion of the battery compartment and holds the battery toward the bottom portion;
a battery case compartment that is provided to the main body case and in which the battery case is accommodated; and
a cut-out portion that is provided at a location on the battery case that is adjacent to the battery case compartment and into which part of a finger is inserted in a state in which the battery case has been pulled out of the main body case.

2. The hearing aid according to claim 1,
wherein the open portion of the battery case compartment that is exposed on the outside in a state in which the battery case has been pulled out of the main body case is larger than the open portion of the cut-out portion.

3. The hearing aid according to claim 1,
wherein the retainer is provided to the bottom portion of the battery compartment.

4. The hearing aid according to a claim 1,
wherein the battery case compartment is provided as a space forming substantially U-shaped inner walls in cross section view of the end of the main body case, the direction in which the substantially U-shaped inner walls open is the direction in which the cut-out portion is provided in the battery case, and the battery case compartment is large enough for at least part of a human fingertip to fit inside.

5. The hearing aid according to claim 1,
wherein the cut-out portion is provided to a side face of the battery case and is substantially U-shaped, and
the direction in which the cut-out opens in a substantially U shape coincides with the direction in which the bottom portion of the bottomed, cylindrical battery case is provided.

6. The hearing aid according to claim 1,
wherein, of a pair of first and second electrodes electrically connected to the battery, at least the second electrode is provided inside the battery compartment so that the direction in which it touches the battery is perpendicular to the insertion and removal direction of the battery.

7. The hearing aid according to claim 6,
wherein the location where the second electrode touches the battery is set so that the direction in which the battery is pressed is opposite to the direction in which the battery case is pulled out from the main body case.

8. The hearing aid according to claim 1,
wherein the retainer is a magnet.

9. The hearing aid according to claim 8,
wherein the retainer is a magnet that is elastic.

10. The hearing aid according to claim 8,
wherein the retainer is a plastic magnet.
